(19) United States
(12) Patent Application Publication
(10) Pub. No.: US 2017/0228757 A1
(43) Pub. Date: Aug. 10, 2017

(54) COUPON MANAGEMENT

(71) Applicant: Hewlett-Packard Development Company, L.P., Houston, TX (US)

(72) Inventors: Larry Mull, Corvallis, OR (US); Lonnie D Mandigo, Corvallis, OR (US)

(21) Appl. No.: 15/515,246

(22) PCT Filed: Sep. 30, 2014
(86) PCT No.: PCT/US2014/058185

§ 371 Date: Mar. 29, 2017

(51) Int. Cl. G06Q 30/02

(52) U.S. Cl. CPC G06Q 30/0224; G06Q 30/0212; G06Q 30/0226

(57) ABSTRACT

Examples relate to coupon management. The examples disclosed herein enable receipt of a request to allocate a new coupon to a user, wherein the new coupon is associated with a first coupon distributor of a set of coupon distributors. In examples, a determination may be made, responsive to receiving the request, as to whether to allocate the new coupon to the user based on a set of delivery statuses associated with a respective set of coupons previously allocated to the user and based on information received from a printer, wherein an individual delivery status comprises information indicating whether an associated coupon has been printed.

### BACKGROUND

Merchants and other types of coupon distributors often make available coupons to products available for purchase by consumers. Coupons may be made available in digital and physical form for redemption by consumers. User consumption of coupons may be monitored.

### BRIEF DESCRIPTION OF THE DRAWINGS

The following detailed description references the drawings, wherein:

FIG. 1 is a block diagram of an example system for coupon management;

FIG. 2 is a block diagram of an example system for coupon management;

FIG. 3 is a block diagram of an example system for coupon management in communication with a plurality of systems;

FIG. 4 is a flowchart of an example method for execution by a system for coupon management; and

FIG. 5 is a flowchart of an example method for execution by a system for coupon management.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

As mentioned above, merchants and other types of coupon distributors often make available coupons to products available for purchase by consumers. Coupons may be made available in digital and physical form for redemption by consumers. User consumption of coupons may be monitored to allow coupon distributors to deliver relevant coupons to those users that actively consume coupons. Coupon distributors may be dependent upon merchants and/or other product providers to whom users redeem coupons to determine whether a user consumes a coupon. It may be difficult for a coupon distributor to track the status of a coupon once it has been delivered and may involve complicated processing for a coupon distributor to determine when to next allocate a coupon to a user. Arbitrarily delivering coupons to a user regardless of whether that user consumed previously delivered coupons may not yield the best consumption results and may decrease user satisfaction with the coupon distributor.

As such, a coupon management system may track the delivery status of digital coupons allocated to a user from various coupon distributors. For example, for each coupon allocated and available to a user, the system may maintain and manage a delivery status for the coupon. In some examples, the system may also maintain a delivery state for the set of coupons allocated and available to the user, a set of coupons from each coupon distributor allocated and available to the user, and/or other groupings of coupons allocated to the user. The system may determine the delivery state for the set of coupons based on the individual delivery statuses of the coupons in the set of coupons.

A delivery status may comprise, for example, pending, processing, printed, submitted, failed, deleted, and/or another delivery status indicator. A pending status may indicate that the coupon is available for the user. A processing status may indicate that printing of the coupon is currently being processed. A printed status may indicate that the coupon was successfully printed. A submitted status may indicate that the coupon was sent for printing, but printing may not be able to be verified. A failed status may indicate that the coupon failed to print for some reason. A deleted status may indicate that the user deleted the coupon, A delivery state for the set of coupons may comprise, for example, the same delivery status indicators as the available delivery statuses for an individual coupon.

The coupon management system may track and manage the delivery status of an individual coupon based on user interaction with the system, information received from components communicably coupled to the system (e.g., a printer which may be used to print the coupon), and/or in other ways, The system may track and manage delivery state of a set of coupons based on individual delivery statuses of each coupon in the set. The coupon management system may manage delivery statuses for coupons allocated to user for each coupon distributor that uses the coupon management system to allocate coupons to users.

Examples disclosed herein address the issue of determining when to allocate a new coupon to a user by determining, responsive to receiving a request to allocate a new coupon to a user from a coupon distributor, whether to allocate the new coupon to the user based on a set of delivery states associated with a respective set of coupons previously allocated to the user and based on information received from a printer, wherein an individual delivery state comprises information indicating whether an associated coupon has been printed by a printer. By considering whether a coupon associated with the coupon distributor has been printed, the coupon management system may control allocation of coupons to a user based on usage of the coupon by the user, and may increase the potential use of the coupon as well as maintain or increase user satisfaction with the coupon distributor.

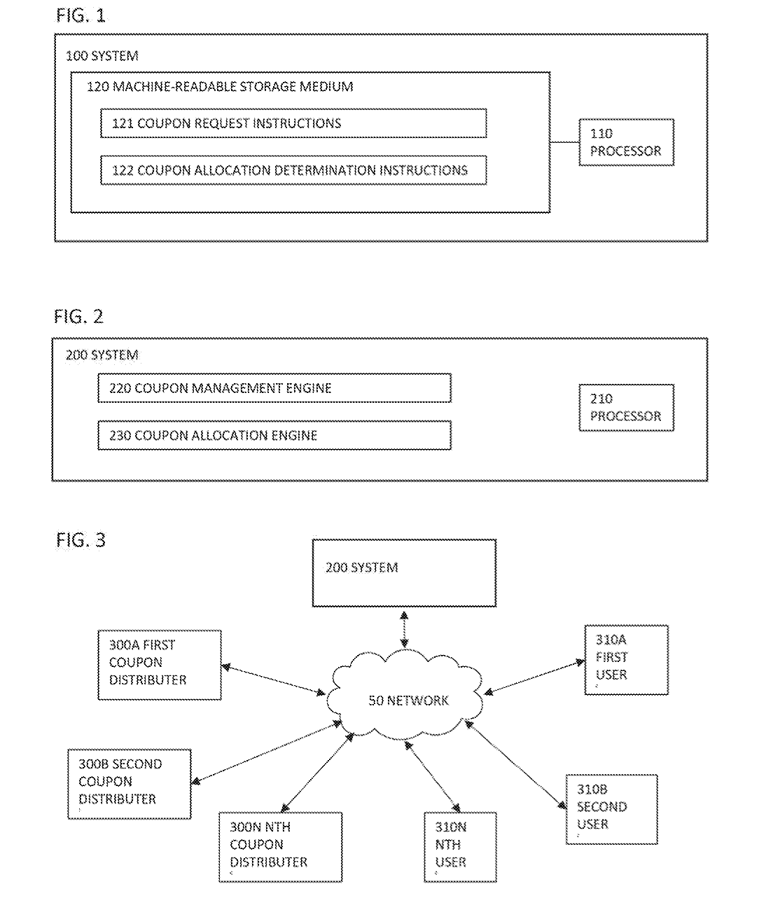

Referring now to the drawings, FIG. 1 is a block diagram of an example system 100 for coupon management. System 100 may be a cloud server, a mainframe, notebook, desktop, tablet, workstation, mobile device, or any other device suitable for executing the functionality described below. In some examples, system 100 may be part of a system of computing devices, such that each computing device in the system may comprise the functionality and/or structure of system 100. In some examples, the system 100 (and/or other computing devices in the system of computing devices) may be management servers that provide services, functionality, information, and/or other data to user groups. In the embodiment of FIG. 1, system 100 includes a non-transitory machine-readable storage medium 120 and a processor 110.

Processor 110 may be one or more central processing units (CPUs), microprocessors, and/or other hardware devices suitable for retrieval and execution of instructions stored in machine-readable storage medium 120. Processor 110 may fetch, decode, and execute program instructions 121, 122 and/or other instructions to enable coupon management, as described below. As an alternative or in addition to retrieving and executing instructions, processor 110 may include one or more electronic circuits comprising a number of electronic components for performing the functionality of one or more of instructions 121, 122, and/or other instructions.

In one example, the program instructions 121, 122, and/or other instructions can be part of an installation package that can be executed by processor 110 to implement the functionality described herein. In this case, memory 120 may be a portable medium such as a CD, DVD, or flash drive or a memory maintained by a computing device from which the installation package can be downloaded and installed. In another example, the program instructions may be part of an application or applications already installed on system 100.

Machine-readable storage medium 120 may be any hardware storage device for maintaining data accessible to system 100. For example, machine-readable storage medium 120 may include one or more hard disk drives, solid state drives, tape drives, and/or any other storage devices. The storage devices may be located in system 100 and/or in another device in communication with system 100. For example, machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for coupon management. As detailed below, storage medium 120 may maintain and/or store the data and information described herein.

Coupon request instructions 121, when executed by processor 110, may receive a request to allocate a new coupon to a user, wherein the new coupon is associated with a coupon distributor of a set of coupon distributors. The coupon request instructions 121, when executed by processor 110, may receive the request from the coupon distributor, may automatically generate the request based on a user's subscription for coupons from the coupon distributor, and/or may otherwise obtain the request. The coupon distributor may communicate with the system 100 via a coupon distributor computing device (as described below in FIG. 3). As such, functionality and description pertaining to a coupon distributor's actions may be implemented by an associated coupon distributor computing device.

Coupon allocation determination instructions 122, when executed by processor 110, may determine, responsive to the request being received, whether to allocate the new coupon to the user based on a set of delivery statuses associated with a respective set of coupons previously allocated to the user. For example, the coupon allocation determination instructions 122, when executed by processor 110, may determine, responsive to the request being received, whether to allocate the new coupon to the user based on a set of delivery statuses associated with a respective set of coupons previously allocated to the user and based on information received from a printer communicably coupled to system 100, wherein an individual delivery status may comprise information indicating whether an associated coupon has been printed by a printer.

The coupon allocation determination instructions 122, when executed by processor 110, may determine a relevant set of coupons from which to determine whether to allocate the new coupon. The coupon allocation determination instructions 122, when executed by processor 110, may determine the set of coupons based on a coupon distributor that requests to allocate the coupon. For example, the coupon allocation determination instructions 122, when executed by processor 110, may determine the set of coupons based on coupons allocated to the user from the coupon distributor.

In some examples, the request to allocate the new coupon may include information about which coupons to include in a set for consideration. In an example in which the request does not include information, the coupon allocation determination instructions 122, when executed by processor 110, may select each coupon allocated and available to the user as the set of coupons. In another example in which the request does not include information, the coupon allocation determination instructions 122, when executed by processor 110, may select each coupon allocated and available to the user from the coupon distributor that provided the request as the set of coupons. Responsive to the request including information about the coupons to include, the coupon allocation determination instructions 122, when executed by processor 110, may determine the set of coupons based on the included information.

In some examples, the coupon allocation determination instructions 122, when executed by processor 110, may determine whether to allocate the new coupon based on a coupon allocation policy of the coupon distributor. The coupon allocation policy for a coupon distributor may be received as information with the request, may be stored in the storage medium 120, and/or may be otherwise obtained.

The coupon allocation policy for a coupon distributor may include, for example, a set of conditions based on which a new coupon may be allocated to a user. The coupon allocation policy for a first coupon distributor may be different from a coupon allocation policy for a second coupon distributor. In some examples, a predetermined set of conditions may be available as a coupon allocation policy for a coupon distributor. In other examples, a coupon distributor may provide the set of conditions for the system to monitor.

An individual condition may comprise one or more criteria based on which a new coupon may be allocated. For example, an individual condition may require that a majority of the coupons, a predetermined percentage, and/or other metric related to coupons allocated to the user from the coupon distributor have been printed. In another example, an individual condition may require that a majority of the coupons, a predetermined percentage, and/or other metric related to coupons allocated to the user in a predetermined time period have been printed. In another example, an individual condition may require that less than a majority of the coupons, a predetermined percentage, and/or other metric related to coupons allocated to the user have been deleted. In another example, an individual condition may require that less than a majority of the coupons, a predetermined percentage, and/or other metric related to coupons allocated to the user have been deleted in a predetermined time period. An individual condition may include other requirements as well, and is not limited to the example described herein.

Responsive to determining that a condition the set of conditions of the coupon allocation policy of the coupon distributor has been met, the coupon allocation determination instructions 122, when executed by processor 110, may allocate the new coupon to the user. Responsive to determining that the none of the set of conditions have been met, the coupon allocation determination instructions 122, when executed by processor 110, may send a notification to the coupon distributor indicating that the new coupon should not be allocated at this time, may send a reminder to the coupon distributor to provide another request to allocate a new coupon in a predetermined amount of time, and/or may otherwise send information to the coupon distributor indicating that the new coupon should not be allocated.

In examples in which no coupon allocation policy is stored for the coupon distributor, the coupon allocation determination instructions 122, when executed by processor 110, may determine whether to allocate the new coupon by determining whether a majority of the delivery statuses of the set of delivery statuses for the allocated coupons indicate that the associated coupons have been printed. Responsive to determining that the majority of delivery statuses indicate that the associated coupons have been printed, the system may allocate the new coupon to the user. Responsive to determining that the majority of delivery statuses do not indicate that the associated coupons have been printed, the coupon allocation determination instructions 122, when executed by processor 110, may send a notification to the coupon distributor indicating that the new coupon should not be allocated at this time, may send a reminder to the coupon distributor to provide another request to allocate a new coupon in a predetermined amount of time, and/or may otherwise send information to the coupon distributor and/or other coupon distributors that may send coupons to the user indicating that the new coupon should not be allocated.

In some examples, the coupon allocation determination instructions 122, when executed by processor 110, may determine whether to allocate the new coupon by determining whether a majority of delivery statuses of the set of delivery statuses indicate that coupons allocated from the first coupon distributor have been printed. Responsive to determining that the majority of delivery statuses of coupons associated with the coupon distributor indicate that the associated coupons have been printed, the system may allocate the new coupon to the user. Responsive to determining that the majority of delivery states for coupons associated with the coupon distributor do not indicate that the associated coupons have been printed, the coupon allocation determination instructions 122, when executed by processor 110, may send a notification to the coupon distributor indicating that the new coupon should not be allocated at this time, may send a reminder to the coupon distributor to provide another request to allocate a new coupon in a predetermined amount of time, and/or may otherwise send information to the coupon distributor indicating that the new coupon should not be allocated.

In some examples, the coupon allocation determination instructions 122, when executed by processor 110, may determine whether to allocate the new coupon by determining whether coupons allocated to the user have been deleted. For example, responsive to a majority of delivery statuses, other predetermined amount of delivery statuses, a predetermined percentage of delivery statuses, and/or other metric related to the number of coupons having been deleted based on the associated delivery statuses, the coupon allocation determination instructions 122, when executed by processor 110, may determine to not allocate the new coupon, Responsive to determining not to allocate the new coupon, the coupon allocation determination instructions 122, when executed by processor 110, may send a notification to the coupon distributor indicating that the new coupon should not be allocated at this time, may send a reminder to the coupon distributor to provide another request to allocate a new coupon in a predetermined amount of time, and/or may otherwise send information to the coupon distributor indicating that the new coupon should not be allocated.

In some examples, the coupon allocation determination instructions 122, when executed by processor 110, may maintain a delivery state of a set of coupons of the user. The set of coupons may comprise the coupons allocated to the user, the coupons allocated and available for use by the user, coupons allocated by a particular coupon distributor, and/or other set of coupons. The delivery state for the set of coupons may comprise a single delivery status indicator that may be applied to the set of coupons. The coupon allocation determination instructions 122, when executed by processor 110, may determine the delivery state of the set of coupons based on a majority of the coupons being a particular status, a predetermined percentage of coupons being a predetermined status, and/or based on other criteria.

The coupon allocation determination instructions 122, when executed by processor 110, may determine whether to allocate the new coupon based on the delivery state of the relevant set of coupons (e.g., coupons allocated from the coupon distributor which wants to allocate the new coupon, and/or other relevant set of coupons). The coupon allocation determination instructions 122, when executed by processor 110, may determine whether to allocate the new coupon based on the delivery state of the set of coupons in examples similar to those described above, but is not limited to the examples described herein.

The functionalities described with respect to FIG. 1 may be implemented by engines and/ or other hardware components of a system. For example, the functionalities of FIG. 1 may be provided in combination with functionalities described below in relation to any of FIGS. 2-5.

FIG. 2 is a block diagram of an example system 200 for coupon management. As with system 100, system 200 may be a cloud server, a mainframe, notebook, desktop, tablet, workstation, mobile device, or any other device suitable for executing the functionality described below. As with processor 110 of FIG. 1, processor 220 may be one or more CPUs, microprocessors, and/or other hardware devices suitable for retrieval and execution of instructions.

As detailed below, system 200 may include a series of engines 220-230 for coupon management. Each of the engines may generally represent any combination of hardware and programming. For example, the programming for the engines may be processor executable instructions stored on a non-transitory machine-readable storage medium and the hardware for the engines may include at least one processor of the system 200 to execute those instructions. In addition or as an alternative, each engine may include, one or more hardware devices including electronic circuitry for implementing the functionality described below.

Coupon management engine 220 may manage, for each coupon in a set of coupons allocated to a user, an individual delivery status. Based on the individual delivery status of each coupon in the set of coupons, the coupon management engine 220 may determine a delivery state for the set of coupons. The set of coupons may comprise, for example, each coupon allocated to the user, each coupon allocated to the user from a coupon distributor, each coupon allocated within a predetermined time period, and/or other set of coupons. As mentioned above, a delivery status may comprise, for example, pending, processing, printed, submitted, failed, deleted, and/or another delivery status.

The coupon management engine 220 may manage a delivery status of are individual coupon. For example, responsive to the coupon being allocated, the coupon management engine 220 may store a delivery state of pending for the coupon in the storage medium 120.

The coupon management engine 220 may change an individual delivery state responsive to action being taken with respect to the individual coupon. For example, responsive to a coupon being printed, the coupon management engine 220 may change a delivery status for the coupon to printed, submitted, or failed. The coupon management engine 220 may change the delivery status to printed responsive to receiving information from a printer communicably coupled to the system 200 indicating that the coupon was successfully printed. In another example, the coupon management engine 220 may change the delivery status for a coupon to submitted responsive to the coupon being submitted for printing to a printer from which confirmation may not be received. In another example, the coupon management engine 220 may change the delivery status for a coupon to failed responsive to receiving information from a printer communicably coupled to the system 200 indicating that the coupon was not printed. The coupon management engine 220 may also change the delivery status of a coupon to deleted responsive to the coupon being deleted. The coupon management engine 220 may change delivery status for a coupon in other situations as well, and is not limited to the examples described herein.

In some examples, the coupon management engine 220 may maintain allocated coupons in a digital mailbox that may comprise coupons and/or other digital documents. The digital mailbox (via the coupon management engine 220) may execute default rules. The default rules may be accepted by the user of the digital mailbox. For example, a default rule may comprise automatically printing a coupon responsive to the coupon being allocated, deleting a coupon responsive to a predetermined amount of time passing since the coupon was allocated, and/or other default rules. The coupon management engine 220 may perform any default rules for the digital mailbox, and may update a delivery status of coupons as necessary based on performing a default rule.

In some examples, the coupon management engine 220 may also maintain delivery states for multiple sets of coupons in the digital mailbox based on the delivery statuses of the coupons in each set of coupons. For example, the coupon management engine 220 may maintain a delivery state for all of the coupons in the digital mailbox, a set of coupons allocated from each individual coupon distributor from whom coupons have been allocated, a set of coupons allocated in a predetermined time period, and/or other sets of coupons.

In some examples, the coupon management engine 220 may perform this functionality in a manner the same as or similar to that of the coupon request instructions 121, coupon allocation determination instructions 122, and/or other instructions of system 100. Further details regarding an example implementation of coupon management engine 220 are provided above in connection with coupon request instructions 121, coupon allocation determination instructions 122, and/or other instructions of FIG. 1.

Coupon allocation engine 230 may determine whether to allocate a coupon to the user based on delivery statuses of coupons and/or the delivery state o a set of coupons allocated to a user.

Coupon allocation engine 230 may also manage a set of coupon allocation policies for a respective set of coupon distributers that allocate coupons via the system 200. For example, for an individual coupon distributor, the coupon allocation engine 230 may receive a coupon allocation policy, may store the coupon allocation policy in the storage medium 120, may receive and apply revisions to the stored, coupon allocation policy, may apply the coupon allocation policy while determining whether to allocate a new coupon from the coupon distributor, and/or may otherwise manage the coupon allocation policy for the individual coupon distributor. In some examples, the coupon allocation engine 230 may also provide, to the coupon distributor, a suggestion of a condition to include in the set of conditions of the coupon allocation policy of a coupon distributor based on tracking trends of user interaction with coupons from the coupon distributor.

In some examples, coupon allocation engine 230 may also determine which coupon to allocate based on a coupon allocation policy of a coupon distributor allocating the coupon, previous user history related to use of coupons from the coupon distributor, previous user history related to use of coupons from any coupon distributor, and/or other information related to the coupon and/or the user.

Coupon allocation engine 230 may determine ether to allocate the new coupon and perform functionality in a manner the same as or similar to that of coupon allocation determination instructions 122. Further details regarding an example implementation of coupon management engine 220 are provided above in connection with coupon allocation determination instructions 122.

FIG. 3 is a block diagram of an example system for coupon management, where the system is in communication with user computing devices and coupon distributor computing devices over a network. In the example depicted in FIG. 3, the system 200 may communicate with a set of coupon distributer computing devices 300A, 300B, . . . , 300N and a set of user computing devices 310A, 310B, . . . , 310N, where each coupon distributor computing device and user computing device may be communicably coupled to the system 100 via a network 50. The network 50 may be any wired, wireless and/or other type of network via which the coupon distributor computing devices and/or user computing devices may communicate with the system 100.

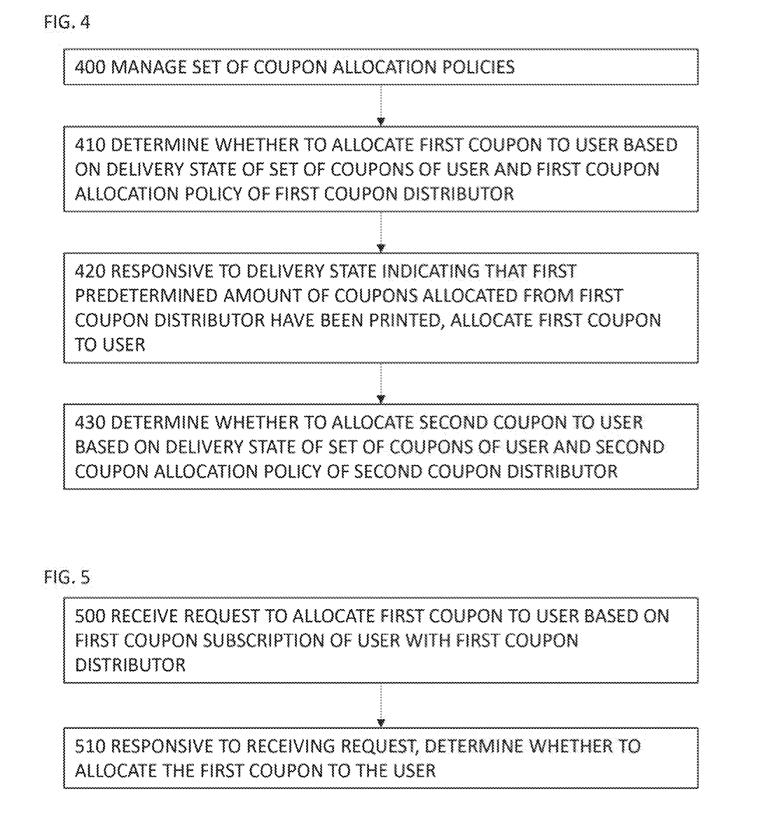

FIG. 4 is a flowchart of an example method for execution by a system for coupon management.

Although execution of the methods described below are with reference to system 100 of FIG. 1 and/or system 200 of FIGS. 2 and 3, other suitable devices for execution of this method will be apparent to those of skill in the art. The method described in FIG. 4 and other figures may be implemented in the form of executable instructions stored on a machine-readable storage medium, such as storage medium 120, by one or more engines described herein, and/or in the form of electronic circuitry.

In an operation 400, a set of coupon allocation policies may be managed. For example, the system 100 (and/or the coupon allocation determination instructions 122, the coupon management engine 220, coupon allocation engine 230, or other resource of the system 100) may manage the set of coupon allocation policies. The system 100 may manage the set of coupon allocation policies in a manner similar or the same as that described above in relation to the execution of the coupon allocation determination instructions 122, the coupon management engine 220, coupon allocation engine 230, and/or other resource of the system 100.

In an operation 410, a determination may be made as to whether to allocate a first coupon to the user based on a delivery state of a set of coupons of the user and a first coupon allocation policy of a first coupon distributor. For example, the system 100 (and/or the coupon allocation determination instructions 122, the coupon management engine 220, coupon allocation engine 230, or other resource of the system 100) may determine whether to allocate the first coupon. The system 100 may determine whether to allocate the first coupon in a manner similar or the same as that described above in relation to the execution of the coupon allocation determination instructions 122, the coupon management engine 220, coupon allocation engine 230, or other resource of the system 100.

In an operation 420, the first coupon may be allocated to the user responsive to the delivery state indicating that a first predetermined amount of coupons allocated from the first coupon distributor have been printed, For example, the system 100 (and/or the coupon allocation determination instructions 122, the coupon management engine 220, coupon allocation engine 230, or other resource of the system 100) may allocate the first coupon. The system 100 may allocate the first coupon in a manner similar or the same as that described above in relation to the execution of the coupon allocation determination instructions 122, the coupon management engine 220, coupon allocation engine 230, or other resource of the system 100.

In an operation 430, determination may be made as to whether to allocate a second coupon to the user based on a second delivery state of a set of coupons of the user and a second coupon allocation policy of a second coupon distributor. For example, the system 100 (and/or the coupon allocation determination instructions 122, the coupon management engine 220, coupon allocation engine 230, or other resource of the system 100) may determine whether to allocate the second coupon. The system 100 may determine whether to allocate the second coupon in a manner similar or the same as that described above in relation to the execution of the coupon allocation determination instructions 122, the coupon management engine 220, coupon allocation engine 230, and/or other resource of the system 100.

FIG. 5 is a flowchart of an example method for execution by system for coupon management.

In an operation 500, a request may be received to allocate a first coupon to a user based on a first coupon subscription of the user with the first coupon distributor. For example, the system 100 (and/or the coupon request instructions 121, the coupon management engine 220, or other resource of the system 100) may receive the request. The system 100 may receive the request in a manner similar or the same as that described above in relation to the execution of the coupon request instructions 121, the coupon management engine 220, and/or other resource of the system 100.

In an operation 510, a determination may be made as to whether to allocate the first coupon to the user responsive to receiving the request. For example, the system 100 (and/or the coupon allocation determination instructions 122, the coupon management engine 220, coupon allocation engine 230, or other resource of the system 100) may determine whether to allocate the first coupon. The system 100 may determine whether to allocate the first coupon in a manner similar or the same as that described above in relation to the execution of the coupon allocation determination instructions 122, the coupon management engine 220, coupon allocation engine 230, and/or other resource of the system 100.

The foregoing disclosure describes a number of example embodiments for coupon management. The disclosed examples may include systems, devices, computer-readable storage media, and methods for coupon management. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Further, the sequence of operations described in connection with FIGS. 1-5 Are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this, disclosure and protected by the following claims.

We claim:

1. A non-transitory machine-readable storage medium comprising instructions for coupon management, the instructions executable by a processor of a system to:
receive a request to allocate a new coupon to a user, wherein the new coupon is associated with a first coupon distributor of a set of coupon distributors; and
responsive to receiving the request, determine whether to allocate the new coupon to the user based on a set of delivery statuses associated with a respective set of coupons previously allocated to the user and based on information received from a printer communicably coupled to the system, wherein an individual delivery status comprises information indicating whether an associated coupon has been printed.

2. The storage medium; of claim 1, further comprising instructions executable by the processor of the system to:
responsive to determining that a majority of delivery statuses of the set of delivery statuses indicate that respective associated coupons have been printed, allocate the new coupon to the user.

3. The storage medium of claim 1, further comprising instructions executable by the processor of the system to;
responsive to determining that a majority of delivery statuses of the set of delivery states indicate that coupons allocated from the first coupon distributor have, been printed, allocate the new coupon to the user.

4. The storage medium of claim 1, further comprising instructions executable by the processor of the system to:
responsive to determining that a majority of coupons allocated to the user from the first coupon distributor have been deleted based on delivery statuses of coupons allocated to the user from the first coupon distributor, determine not to allocate the coupon to the user.

5. The storage medium of claim 1, further comprising instructions executable by the processor of the system to:
determine whether to allocate the new coupon to the user based on a set of conditions included in a coupon allocation policy of the first coupon distributor.

6. The storage medium of claim 5, wherein the set of conditions comprise a condition that a predetermined percentage of coupons allocated to the user from the first coupon distributor have been printed, and
wherein the storage medium further comprises instructions executable by the processor of the system to:
allocate the new coupon responsive to determining that the condition is met.

7. A system for coupon management, the system comprising:
a coupon management engine to:
manage, for each coupon in a set of coupons allocated to a user, an individual delivery status, the individual delivery status comprising information indicating whether an individual coupon has been printed; and
based on the individual delivery status of each coupon in the set of coupons, determine a delivery state for the set of coupons; and
a coupon allocation engine to:
determine whether to allocate a new coupon to the based on the delivery state for the set of coupons.

8. The system of claim 7, wherein the coupon allocation engine is to:
determine whether to allocate the new coupon from a first coupon distributor associated with at least one coupon of the set of coupons allocated to the user based on a set of conditions included in a coupon allocation policy of the first coupon distributor.

9. The system of claim 8, wherein the coupon allocation engine is to:
responsive to determining to allocate the new coupon from the first coupon distributor to the user, determine which coupon to allocate based on the coupon allocation policy of the first coupon distributor and previous user behavior of the user regarding coupons allocated from the first coupon distributor.

10. The system of claim 7, wherein the coupon allocation engine is to:
allocate the new coupon from the first coupon distributor to the user responsive to the delivery state indicating that a majority of coupons in the set of coupons have been printed.

11. The system of claim 10, wherein the coupon management engine is to:
change an individual delivery status for an individual coupon responsive to receiving information from a printer communicably coupled to the system, wherein the information from the printer indicates that the individual coupon being printed.

12. A method for execution by a system or coupon management, the method comprising:
managing, for a set of coupon distributors, a respective set of coupon allocation Polices;
determining, based on a delivery state of a set of coupons allocated to the user and a first coupon allocation policy of a first coupon distributor of the set of coupon distributors, whether to allocate a first coupon to the user, wherein the first coupon allocation policy comprises a first set of conditions including a first condition indicating a first predetermined amount of coupons allocated from the first coupon distributor to be printed;
responsive to the delivery state of the set of coupons indicating that the first predetermined amount of coupons allocated from the first coupon distributor have been printed, allocating the first coupon to the user; and
determining, based on the delivery state of a set of coupons allocated to the user and a second coupon allocation policy of a second coupon distributor of the set of coupon distributors, whether to allocate a second coupon to the user, wherein the second coupon allocation policy comprises a second set of conditions including a second condition indicating a second predetermined amount of coupons different from the first predetermined amount allocated from the second coupon distributor to be printed.

13. The method of claim 12, further comprising:
determining to not allocate the first coupon to the user responsive to determining that a predetermined amount of coupons from the first coupon distributor have been deleted.

14. The method of claim 12, further comprising:
receiving a request to allocate the first coupon to the user based on a first coupon subscription of the user with the first coupon distributor; and
responsive to receiving the request, determining whether to allocate the first coupon to the user.

15. The method of claim further comprising:
receiving an indication from the user regarding whether to automatically print coupons allocated to the user.
